(19) United States
(12) Patent Application Publication
(10) Pub. No.: US 2025/0327458 A1
(43) Pub. Date: Oct. 23, 2025

(54) MEDIA GAP MOTOR, FUEL CELL SYSTEM AND USE

(71) Applicant: G+L INNOTEC GMBH, Laupheim (DE)

(72) Inventors: Ralf Heber, Erbach-Ersingen (DE); Holger Gödeke, Stetten (DE); Christoph KLUNKER, München (DE)

(21) Appl. No.: 18/726,622

(22) PCT Filed: Jan. 4, 2023
(86) PCT No.: PCT/EP2023/050095

§ 371 Date: Jun. 24, 2025

(30) Foreign Application Priority Data
Jan. 4, 2022 (EP) 22150213.1

(51) Int. Cl. F04D 25/06; B60L 50/72; H01M 8/04111

(52) U.S. Cl. CPC F04D 25/06; B60L 50/72; H01M 8/04111; H01M 2250/20

(57) ABSTRACT

The present application relates to a media gap motor (10) and also a fuel cell system (1) comprising a media gap motor (10). The application additionally relates to a use of the media gap motor (10) and of the fuel cell system (1). The proposed media gap motor (10), for example for a fuel cell system (1), has a shaft (15), in which there is accommodated a rotor magnet (22). The media gap motor (10) additionally has a stator with stator windings (23) for electrically driving a rotation of the shaft (15). The media gap motor (10) furthermore has a housing (26), which delimits a flow space (11) formed between the shaft (15) and the stator. The media gap motor (10) further has an impeller (13) disposed in the flow space (11) and on the shaft.

The present application relates to a media gap motor, in particular for a fuel cell system, and to a fuel cell system comprising a media gap motor. The application additionally relates to a use of the media gap motor and of the fuel cell system.

Vehicles with fuel cell systems that provide electric drive power are known. Typically, hydrogen-oxygen fuel cells with a proton exchange membrane are used here. The fuel here is hydrogen and is fed to an anode side of the fuel cell via an anode circuit. The oxidizing agent here is oxygen and is fed to a cathode of the fuel cell via a cathode circuit, where it reacts with the fuel to generate energy. For example, the publication DE 10 2016 015 266 A1 describes prior art of a related kind, in which an air supply device with a turbine wheel and an impeller is disposed in the cathode circuit. Air bearings here perform both radial and axial bearing tasks.

By contrast, it is an object of the present application to propose an improved media gap motor and an improved fuel cell system and their use. In particular, it is an object of the present application to propose a media gap motor which ensures high efficiency with a particularly compact and durable arrangement and at the same time is comparatively easy to manufacture. Furthermore, it is an object of the present application to propose a correspondingly advantageous fuel cell system and a correspondingly advantageous use.

These objects are achieved by a media gap motor having the features of claim 1 and by a fuel cell system and a use having the features of further claims. Advantageous developments may be found with the features of the dependent claims and the exemplary embodiments.

The proposed media gap motor, for example for a fuel cell system, has a shaft, in which there is accommodated a rotor magnet. The media gap motor additionally has a stator with stator windings for electrically driving a rotation of the shaft. The stator windings and the rotor magnet may work together for this purpose. The media gap motor furthermore has a housing, which delimits a flow space formed between the shaft and the stator. The media gap motor further has an impeller disposed in the flow space and on the shaft.

In advantageous embodiments, the media gap motor may have holding ribs that extend in the flow space for radial support of the shaft between the housing and the shaft. The holding ribs therefore generally form a radial bearing for the shaft or part of the radial bearing for the shaft. By providing the holding ribs that extend in the flow space, it is possible to ensure that the media gap motor is particularly robust and durable. Typically, the holding ribs are located completely in the flow space. Generally, the holding ribs have an axial end located upstream and an axial end located downstream, wherein both ends are disposed in the flow space and, for example, a medium to be conveyed flows around them. In some embodiments, a second radial bearing for the shaft may be provided, which in some embodiments may be disposed in the housing of the media gap motor. Generally, the medium to be conveyed does not flow around the second radial bearing for the shaft. By providing the holding ribs in the flow space, the second radial bearing may be formed to be comparatively space-saving and less complex. The holding ribs therefore also have the advantage that the media gap motor is particularly robust, compact and space-saving with a comparatively simple structure.

In some embodiments, the holding ribs are disposed upstream of the impeller. This enables a particularly robust structure to be achieved. The holding ribs may radially support the shaft, for example in the region of an axial end portion of the shaft, particularly on the upstream side. For example, it may be provided for the impeller to be accommodated in a radially widened portion of the flow space. In some embodiments, the holding ribs may be disposed in a portion of the flow space that is narrower in comparison.

Some embodiments of the media gap motor have a turbine wheel. The turbine wheel may be disposed on the shaft. Typically, the housing delimits a further flow space. The turbine wheel may be disposed in the further flow space. Additional holding ribs may also be provided. The further holding ribs may extend in the further flow space between the housing and the shaft to radially support the shaft. The further holding ribs therefore generally form a further radial bearing for the shaft or a part of the further radial bearing for the shaft. The embodiment with the holding ribs and the additional holding ribs is particularly advantageous here because it results in a particularly compact and stable structure. The provision of the holding ribs and the further holding ribs results in a stable radial supporting of the shaft in the flow space and in the further flow space, so that a further radial bearing in the housing or outside the flow space is generally not necessary, whereby a small overall size may be achieved. The flow space and the further flow space are generally fluidically separated from each other. For this purpose, a fluid seal may be provided around the shaft in a region between the impeller and the turbine wheel. A radial bearing between the impeller and the turbine wheel may be provided, but is not absolutely necessary in most embodiments, in contrast to the prior art DE 10 2016 015 266 A1, for example, because the radial support is usually sufficiently provided by the holding ribs and the further holding ribs in the respective flow spaces. This means that no additional installation space is required for complex bearing technology.

In some embodiments, the turbine wheel is disposed between the further holding ribs and the impeller. This creates a robust and simultaneously space-saving arrangement. In some embodiments, it is provided that the impeller and the turbine wheel are disposed between the holding ribs and the further holding ribs. This allows a particularly robust support and high rigidity to be achieved through the holding ribs and the further holding ribs. The holding ribs and the further holding ribs may each act on one of two portions of the shaft disposed at opposite ends of the shaft.

By providing the turbine wheel, some of the energy of the medium flowing out through the further flow space may be used to drive the impeller. Driving of the impeller may be implemented by the stator windings and the rotor magnet of the media gap motor or assisted by these. In particular, it may be advantageous for the media gap motor to start up the impeller electrically in order to increase the efficiency of the media gap motor. In the embodiment with a turbine wheel, the flow space may form part of an intake system and the further flow space part of an outflow system. By driving the turbine wheel in the outflow system, a medium pressure in the intake system may be increased so that the media gap motor may supply more medium and efficiency is increased. In the case of an application of the media gap motor for a fuel cell system, for example, a hydrogen pressure in a hydrogen feed line for a fuel cell may be increased efficiently in this way.

The rotor magnet is typically accommodated in a portion of the shaft that is disposed in the flow space. A further rotor magnet may also be provided, which is accommodated in another portion of the shaft and which is accommodated, for example, in a portion of the shaft that is disposed in the further flow space. In some embodiments, however, it may be provided that the rotor magnet is accommodated in a portion of the shaft that is disposed in the further flow space or outside the flow space. In the embodiment with the further rotor magnet, which is accommodated in the portion of the shaft that is disposed in the further flow space, further stator windings may be provided, which are configured to cooperate with the further rotor magnet to electrically drive a rotation of the shaft. This embodiment is particularly well-balanced and allows a robust arrangement in which the resulting rotation of the shaft is driven by targeted current flow in the first stator windings and in the second stator windings and thus by action on different axial portions of the shaft. It may be provided that the further holding ribs are disposed in the further flow space so that the further holding ribs have an axial overlap with the further rotor magnet and/or with the further stator windings. This enables a particularly robust arrangement to be achieved.

In some embodiments, the holding ribs are configured to generate a swirl in a medium conveyed in the flow space. In this way, the holding ribs may, for example, form a leading grid upstream of the impeller and/or a trailing grid downstream to generate the swirl in the conveyed medium. For this purpose, it may be provided that the holding ribs or at least some of the holding ribs are angled to generate the swirl. For example, the holding ribs run at an angle to the axial direction such that a swirl is generated in the conveyed medium as a result of said medium flowing against the holding ribs. In this way, the flow properties may be optimized by means of the holding ribs. In this case, the impeller blades are subjected to a different flow compared to non-angled holding ribs, which means that a higher efficiency of the media gap motor may be achieved. It may therefore be particularly advantageous if the holding ribs are disposed upstream of the impeller. The holding ribs therefore also have the function of generating swirl in the medium. Especially in conjunction with the droplet separator described below, the generation of swirl in the medium may be particularly advantageous, as explained below.

The holding ribs are generally accommodated in the flow space in such a way that the medium flows through the holding ribs from an upstream end of the holding ribs to a downstream end of the holding ribs. The flow space may be formed at least partially or completely by a gap between the shaft and the housing, in particular a substantially hollow-cylindrical gap. The holding ribs may be disposed evenly or regularly around a circumference. In typical embodiments, the media gap motor has at least two or at least three and/or a maximum of 24 holding ribs in the flow space along the circumferential direction. Spaces are generally formed between adjacent holding ribs, through which the entire conveyed medium or at least part of the conveyed medium flows. In typical embodiments, the holding ribs are elongated in the axial direction and extend in the axial direction. In addition, in typical embodiments, the holding ribs extend between the shaft and the housing in a substantially radial direction. As a rule, no coils or windings of the stator and in particular no solid objects are disposed in the gaps through which the medium flows. The gaps are typically limited on both sides in the circumferential direction by the holding ribs. In a radially outer region, the gaps are usually limited by an inner wall of the housing. An extent of the gaps through which the medium flows is generally at least a quarter, in particular at least half, and/or at most eight times, in particular at most four times, the outer diameter of the shaft in an axial region in which the holding ribs are disposed. It may be provided that the stator windings are disposed beyond a radial seal of the flow space, whereby both the magnetic flux and the flow properties may be optimized.

For example, it may be provided that the holding ribs and/or a bearing part connected to the holding ribs form a radial air bearing for the shaft. However, it is also possible for the holding ribs and/or the connected bearing part to form a radial bearing in contact with the shaft. The bearing part may connect two or more holding ribs. The bearing part is typically held by the holding ribs. The bearing part may be a sleeve, for example, in particular a cylindrical sleeve. The sleeve may surround the shaft, especially all the way around. It is possible that the sleeve is connected to radially inner portions of the holding ribs. In some embodiments, it may also be provided that the gaps are delimited in a radially inner region by the sleeve.

In some embodiments, the media gap motor has a portion for axial support of the shaft. The portion may be embodied as part of the holding ribs or connected to the holding ribs. In particular, the portion in a radially inner region of the holding ribs may be embodied as part of the holding ribs or connected to the holding ribs. The portion may, for example, be formed as part of the sleeve described above. The portion may, for example, have a projection that surrounds the shaft for axial support or that engages in the shaft for axial support. In particular, it may be provided that the portion partially or completely surrounds an axial end portion of the shaft. In some embodiments it is provided that the portion, to axially support the shaft, acts on a surface of the shaft that for example has a surface normal in the axial direction. The surface of the shaft may, for example, be an end face of the shaft. In this embodiment, the surface may define an axial end of the shaft. It may also be provided that the bearing portion acts on a step of the shaft, for example on a surface that has a surface normal in the axial direction. The portion is usually connected to at least one of the holding ribs. The holding ribs may therefore also have the function of contributing to the axial supporting of the shaft.

As mentioned, the rotor magnet is typically accommodated in a portion of the shaft that is disposed in the flow space. In typical embodiments, the rotor magnet may be disposed upstream of the impeller, in particular in the narrower portion of the flow space. It may furthermore be provided that the holding ribs are disposed such that the holding ribs have an axial overlap with the rotor magnet and/or with the stator windings. In this way, a compact construction with a comparatively short axial length may be achieved. In this way, the holding ribs may also be used to achieve efficient cooling of the stator via the media flow, because the medium has greater wall contact in the region of the rotor magnet and/or the stator windings. In particularly preferred embodiments the holding ribs, to optimize a magnetic flux, form an active part of a magnetic circuit formed by the rotor magnet and stator windings. For example, it may be possible for the holding ribs to continue the stator teeth in the flow space, so to speak, and thus improve the magnetic flux in a particularly advantageous way. The magnetic field may be guided here from the stator windings, which may be disposed outside the flow space, via the holding ribs in a radial direction through the flow space and to the rotor. The holding ribs may have magnetically conductive properties for this purpose. For example, the holding ribs may have stator laminations. The stator may also have stator laminations. It is possible that the holding ribs continue the stator laminations into the flow space. The stator laminations of the holding ribs and the stator may be formed as a one-piece stator laminated core with individual laminations, i.e. as a continuous stator laminated core in particular with regard to the individual laminations. This means that, in addition to their function of supporting the shaft, the holding ribs may also contribute to improving the magnetic flux. The holding ribs may be used here to focus the magnetic flux lines from the stator to the rotor magnet and reduce leakage losses.

A suitable length of the holding ribs in the axial direction is generally at least 5 mm and/or at most 150 mm, in particular at most 100 mm. A radial extent of the holding ribs in the flow channel is generally at least 5 mm and/or at most 250 mm, in particular at most 150 mm. The width of the holding ribs in the circumferential direction may be at least 0.5 mm and/or at most 10 mm, in particular at most 5 mm. In addition to the stator laminations that may be present, the holding ribs are generally made of non-magnetically conductive materials such as plastic or an aluminum alloy. The fixing methods for the holding ribs may be an insertion sleeve, an adhesive/welded connection, caulking and/or an injection-molded component integrated in the stator housing.

In some embodiments, a media gap motor is provided in which the shaft has a one-piece reinforcement. The reinforcement may have a first portion and a second portion. The rotor magnet may be accommodated inside the first portion of the reinforcement. Furthermore, the impeller may be disposed on the second portion of the reinforcement. The first and second portions of the reinforcement may be directly adjacent to each other or axially spaced apart. The impeller may, for example, be pressed onto the second portion of the reinforcement. For a particularly robust and torsion-resistant arrangement, it may be provided that the reinforcement runs through the impeller with the second portion over a significant region of an axial length of the impeller. For example, it may be provided that the reinforcement runs through the impeller with the second portion over at least two thirds of the axial length, preferably over the entire axial length, of the impeller. Thus, in some embodiments, the second portion of the reinforcement may be at least as long in the axial direction as the impeller. Advantageously, in some embodiments the impeller may only be mounted on the reinforcement, but not on other components of the shaft. This simplifies production on the one hand and increases the stability of the shaft on the other. The reinforcement is usually hollow on the inside, at least in portions, to accommodate the rotor magnet. The shaft may also have a shaft rod that is accommodated in a cavity inside the reinforcement. The rotor magnet may also be attached to the shaft rod. It may be provided that the shaft or the reinforcement has a continuous cavity in its interior, i.e., in particular a cavity extending over the entire axial length of the shaft or the reinforcement. The shaft may therefore be embodied as a hollow shaft in some embodiments. The rotor magnet and the shaft rod may be accommodated in the continuous cavity. In particular, it may be provided that the continuous cavity of the shaft or the reinforcement extends at least in one region from the impeller to the turbine wheel, if provided. The use of the described reinforcement brings manufacturing advantages, resulting in rigid arrangements with particularly good bending behavior and low unbalance, which are particularly suitable for operation at high speeds. The reinforcement is usually made of a non-magnetic material. The one-piece embodiment of the reinforcement, i.e., in particular the embodiment of the reinforcement as a component made from a continuous piece with constant material properties and/or as a non-joined component, achieves the particular advantages with regard to the improved support of the impeller in conjunction with the rotor magnet. For example, the reinforcement may be made of steel, in particular chrome steel. If the reinforcement is made as a continuous steel part, this results in a particularly torsion-resistant arrangement for the first and second portions accommodating the rotor magnet and the impeller. The impeller may be made of aluminum, for example.

In some embodiments, it is provided that the first portion of the reinforcement has a larger outer diameter than the second portion of the reinforcement. This means that the rotor magnet may be disposed in the portion of the reinforcement with a larger diameter. This results in improved stability with favorable flow efficiency and improved magnetic efficiency. In particular, it may be provided for this purpose that the rotor magnet and the impeller have a radial overlap, for example so that a part of the impeller and a part of the rotor magnet are disposed at the same radial position, but at different axial positions. In some embodiments, a region is formed between the first portion and the second portion of the reinforcement, in which region an outer diameter of the reinforcement is reduced, for example gradually, i.e. for example continuously. The outer diameter may, for example, increase continuously in the region in the direction of the first portion in such a way that a maximum pitch angle of 70 degrees, in particular a maximum pitch angle of 50 degrees, is achieved. In this way, a robust and fluidically particularly advantageous arrangement may be achieved. In particular, edges at the transition between the first portion and the second portion may be avoided. The region may be formed between the first portion and the step mentioned below. In some embodiments, it may be provided that the region in which the outer diameter of the reinforcement decreases, for example gradually, i.e. continuously, is formed between the first portion of the reinforcement and the step. For example, an outer side of the reinforcement and in particular of the shaft between the first portion of the reinforcement and the step may be stepless.

In particularly advantageous embodiments, the second portion of the reinforcement ends with a step. The impeller may be in contact with the step. The step may limit the second portion of the reinforcement, in particular in the direction of the first portion. The step is usually formed in such a way that an outer diameter, which is smaller in the second portion, increases beyond the step when viewed from the second portion. Typically, the impeller is supported on the step. This allows forces resulting from a wobbling movement of the shaft or the reinforcement to be taken up in an advantageous manner. In this way, the rigidity of the shaft may be additionally increased. In a preferred embodiment, the reinforcement is embodied in such a way that a substantially flush, for example continuous, transition is created between the reinforcement and the impeller in the region of the step of the reinforcement. Generally, a structure comprising the shaft and the impeller therefore has no step on a radial outer side of the structure in the region of the reinforcement step, resulting in a smooth transition in the outer contour. For this purpose, a height of the step of the reinforcement may correspond to a radial extent of the impeller bearing against the step. In this way, the flow properties may be improved on the one hand and the stability further increased on the other.

The reinforcement is particularly advantageous in combination with the holding ribs for radial support of the shaft, as this results in a particularly stable construction, especially if the holding ribs or associated bearing parts radially support the shaft in the region of the reinforcement. However, the reinforcement is advantageous in itself, even if no holding ribs are provided. For example, the proposed application may relate to a media gap motor, for example for a fuel cell system, which comprises the shaft in which the rotor magnet is accommodated, the stator with stator windings for electrically driving the rotation of the shaft, the housing which defines a flow space formed between the shaft and the stator, the impeller disposed in the flow space and on the shaft, and the one-piece reinforcement. The media gap motor may also have the advantageous features described above or below.

It may be provided that the media gap motor has a droplet separator. The droplet separator may be disposed in the flow space at the housing or, in other embodiments, in the further flow space. The droplet separator may be a water separator, for example. The droplet separator may be used, for example, to separate liquid water from the media flow. The droplet separator may be disposed on an inner wall of the housing that delimits the flow space or the wider flow space, or may be formed as part of the inner wall. In advantageous embodiments, the droplet separator is disposed at a transition to a portion of the flow space or further flow space, in particular to the widened portion of the flow space that accommodates the impeller or the turbine wheel. The droplet separator is generally disposed in the axial direction between the holding ribs, if provided, and the impeller and/or between the rotor magnet and the impeller. The droplet separator may also be disposed in the axial direction between any further holding ribs provided and the turbine wheel and/or between the further rotor magnet and the turbine wheel. The droplet separator usually has an axial overlap with the shaft. By integrating the droplet separator in the media gap motor as described, a particularly compact arrangement may be achieved, especially in such a way that no further droplet separator is required. Here, for example, a separation of liquid water from a channel for carrying a fuel or an oxidizing agent, for example from a recirculation line, of the fuel cell system may be achieved in a particularly compact and efficient manner. For example, the droplet separator may be formed as a channel and/or an annular channel in which droplets collect during operation. The droplet separator may be fluidically connected to a drain line so that the droplets may be drained via the drain line. In some embodiments, the droplet separator is disposed downstream of the holding ribs. In this way, a compact arrangement may be achieved which, on the one hand, provides stable support for the shaft and, on the other hand, makes optimum use of the installation space in the flow channel for droplet separation. As a rule, the droplet separator is disposed at least in part at an axial position that lies between the impeller and the rotor magnet and/or between the impeller and the holding ribs. This creates optimized functionality in the flow space with a compact construction.

The droplet separator is particularly advantageous in combination with the holding ribs for radial mounting of the shaft, especially if the holding ribs are set up to generate the swirl in a conveyed medium, as this allows a flow pattern optimized for droplet separation to be set. However, the droplet separator is advantageous in itself, even if no holding ribs are provided. For example, the proposed application may relate to a media gap motor, for example for a fuel cell system, which comprises the shaft in which the rotor magnet is accommodated, the stator with stator windings for electrically driving the rotation of the shaft, the housing which defines a flow space formed between the shaft and the stator, the impeller disposed in the flow space and on the shaft, and the droplet separator disposed in the flow space at the housing. The media gap motor may also have the advantageous features described above or below.

The application may further be directed to a fuel cell system comprising a media gap motor as described above or below. The fuel cell system may also have a channel for conducting a fuel. The flow space may form part of the channel for conducting the fuel. The channel may be set up to recirculate the fuel, for example hydrogen, from and to the fuel cell. The impeller may be disposed in the channel for conducting the fuel. In this way, the media gap motor may be used to supply fuel to the fuel cell. As a result, the fuel supply or the recirculation circuit may be precisely load-dependently controlled via the particularly durable media gap motor, which means that lower hydrogen consumption may be achieved. The fuel cell system may have a fuel cell and the media gap motor described above or below and, if necessary, the channel for conducting the fuel. In some embodiments, the fuel cell system is formed as part of a motor vehicle. The application is further directed to a use of a media gap motor as described above or below or a fuel cell system as described above or below for providing electric drive power in a vehicle.

While the media gap motor and the fuel cell system in the embodiments with the described holding ribs are particularly advantageous, the application may also be directed to a fuel cell system which does not necessarily have the holding ribs described above or below, but which has the media gap motor with the shaft in which the rotor magnet is accommodated, the stator with the stator windings for electrically driving the rotation of the shaft, and the housing which delimits the flow space formed between the shaft and the stator, and the impeller disposed in the flow space and on the shaft. The fuel cell system may additionally have any of the advantageous features described above or below.

The fuel cell system may have a channel for conducting an oxidizing agent, in particular oxygen. The channel may have an oxidizing agent feed line for supplying oxidizing agent to the fuel cell. The channel may also have a discharge line for discharging oxidizing agent and/or a reaction product, in particular water, from the fuel cell. The flow space in which the impeller is disposed may form part of the channel for conducting the oxidizing agent. The impeller may be disposed in the channel for conducting the oxidizing agent. In particular, the flow space in which the impeller is disposed may form part of the oxidizing agent feed line. The further flow space in which the turbine wheel is disposed may form part of the discharge line.

The application relates in a particularly advantageous manner to a media gap motor for fuel cell applications or for a fuel cell system, but may also relate generally to a media gap motor which has the advantageous features described above or below. For example, the present application may relate to a media gap motor. This media gap motor may have the described stator, the described rotor and the described impeller. This media gap motor may also include other advantageous features described above or below. For example, the media gap motor may be a media gap motor for a turbocharger.

The features mentioned above or below in relation to the media gap motor are correspondingly transferable to the recirculation fan and its use as well as to the fuel cell system and vice versa.

Exemplary embodiments are described below on the basis of the drawings. In the drawings:

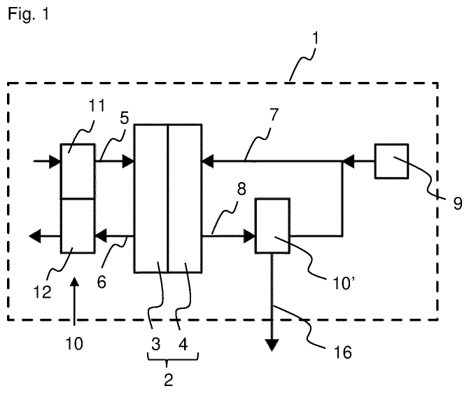

FIG. 1 shows a schematic view of a fuel cell system comprising a media gap motor,

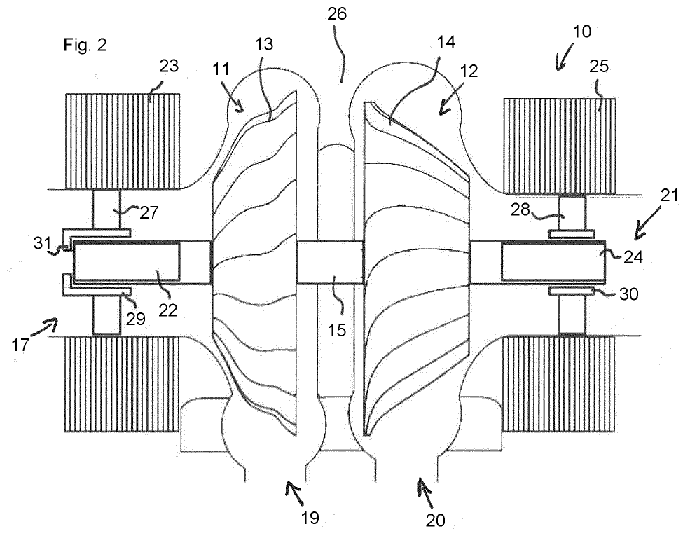

FIG. 2 shows a schematic view of the media gap motor,

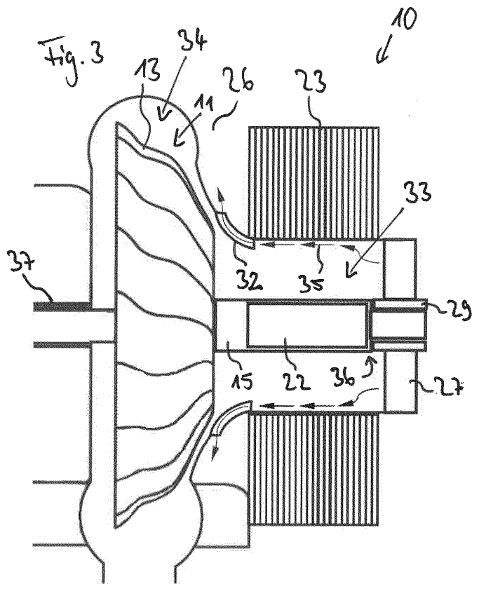

FIG. 3 shows a schematic view of the media gap motor according to a further embodiment,

FIG. 4 shows a schematic view of the media gap motor,

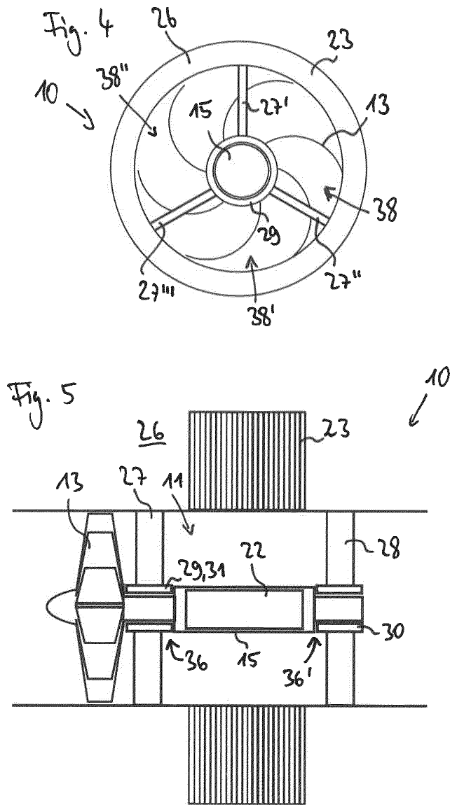

FIG. 5 shows a schematic view of the media gap motor according to a further embodiment,

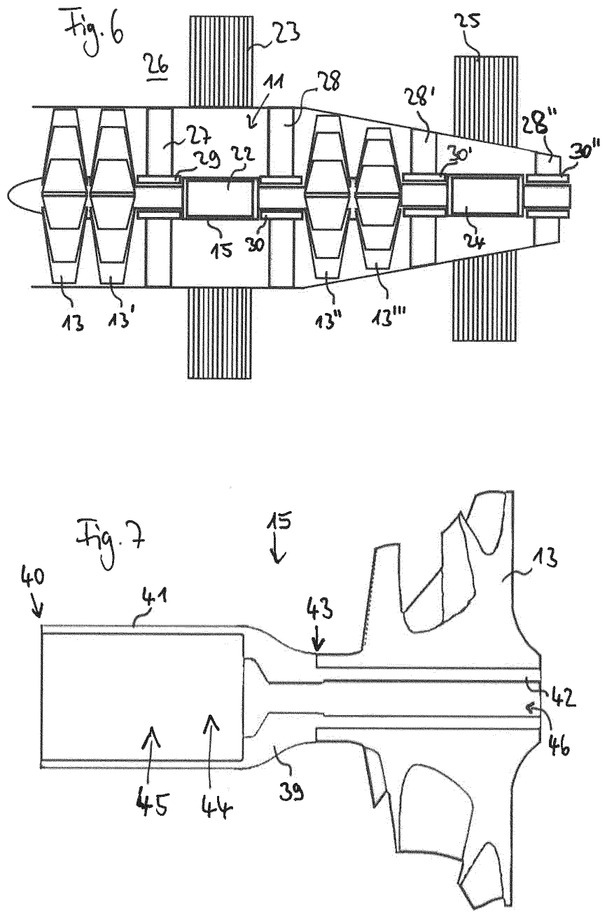

FIG. 6 shows a schematic view of the media gap motor according to a further embodiment and

FIG. 7 shows a sectional view of a shaft of the media gap motor.

FIG. 1 shows a schematic view of a fuel cell system 1. The fuel cell system 1 is installed in a vehicle and is used to provide electrical drive power for the vehicle. The fuel cell system 1 has a fuel cell 2, for example a hydrogen-oxygen fuel cell, with a cathode side 3 and an anode side 4. A cathode circuit is connected to the cathode side 3, via which the fuel cell 2 is supplied with oxygen as an oxidizing agent, for example. For this purpose, the cathode circuit has an oxidizing agent feed line 5, in particular a supply air line, via which the oxidizing agent, for example as a component of air, is supplied to the fuel cell 2, and a discharge line 6, in particular an exhaust air line, via which exhaust air and, if necessary, a reaction product such as water are discharged.

The anode side 4 of the fuel cell 2 is connected to a channel which has a fuel feed line 7 and a fuel discharge line 8. The channel is connected to a fuel source 9, for example a pressurized gas storage tank for the fuel, in particular hydrogen. A fuel is supplied to the anode side 4 of the fuel cell 2 via the fuel feed line 7. Residual fuel that has not been consumed in the fuel cell 2 may be discharged from the fuel cell 2 via the fuel discharge line 8. The unused fuel may then be fed back to the fuel feed line 7 and the anode side 4 of the fuel cell 2, possibly mixed with further fuel from the fuel source 9.

The fuel cell system 1 comprises a media gap motor 10 with a flow space 11 and a further flow space 12, which are shown schematically in the drawing and which form part of the oxidizing agent feed line 5 and the discharge line 6 respectively. As explained in greater detail below, an impeller 13 is accommodated in the flow space 11 and a turbine wheel 14 in the further flow space 12. The impeller 13 and the turbine wheel 14 are coupled to each other via a common shaft 15 to increase efficiency in the cathode circuit.

The fuel cell system 1 also comprises a further media gap motor 10′ in the anode circuit, i.e., in the channel for guiding the fuel or as part of the recirculation fan, more precisely in the fuel discharge line 8. The further media gap motor 10′ has an impeller, described in greater detail below or above, for conveying fuel, which is disposed in a flow space of the further media gap motor 10′ A drain line 16 is also connected to the additional media gap motor 10′, via which water separated in the recirculation circuit may be drained. For this purpose, the drain line 16 is connected to a droplet separator 32 described in greater detail below, which may be disposed in the flow space of the further media gap motor 10′.

FIG. 2 shows a schematic view of the media gap motor 10. Recurring features are marked with the same reference signs in this and the following drawings. The media gap motor 10 has the flow space 11 and the further flow space 12, which are delimited by a common housing 26. The impeller 13 is disposed in the flow space 11. The flow space 11 has an oxidizing agent inlet 17, via which air enters the flow space 11. The air is then compressed by the impeller 13 before the air exits the flow space 11 through an oxidizing agent outlet 19 and is fed to the cathode side 3 of the fuel cell 2. Unused oxidizing agent and any reaction products then enter the further flow space 12 via an exhaust air inlet 20 and drive the turbine wheel 14 there before the medium exits the further flow space 12 again via an outlet 21 of the further flow space 12.

The impeller 13 and the turbine wheel 14 are mounted on the shaft 15 and are thus connected to each other for conjoint rotation. The shaft 15 is embodied as a hollow shaft and has a rotor magnet 22 in an end portion disposed in the flow space 11, which may be driven by generating a current flow in stator windings 23 of a stator with stator laminations. Accordingly, a further rotor magnet 24 is accommodated in a further end portion of the shaft 15 within the further flow space 12, which may be driven by generating a current flow in further stator windings 25 of a stator with stator laminations. In this way, charging may be improved by a balanced electrical drive of the rotation of the shaft 15, so that an efficient fuel supply to the fuel cell 2 is achieved.

The shaft 15 is radially mounted in both opposite end regions in the media gap. For this purpose, the media gap motor 10 has holding ribs 27, which extend between the housing 26 and the shaft 15 in a region of the flow space 11, which lies between the stator windings 23 and the rotor magnet 22. Accordingly, the media gap motor 10 has further holding ribs 28, which extend between the housing 26 and the shaft 15 in a region of the further flow space 12, which lies between the further stator windings 25 and the further rotor magnet 24. In some embodiments, the holding ribs 27 and/or further holding ribs 28 are connected at their radially inner end to an associated cylindrical sleeve 29, 30, by means of which a contacting radial bearing or a radial air bearing of the shaft 15 is achieved in cooperation with the holding ribs 27 and/or further holding ribs 28. Between the impeller 13 and the turbine wheel 14, the housing 26 forms a fluid-tight seal of the flow spaces 11, 12 around the shaft 15. A stable radial mounting of the shaft 15 is generally not necessary at this point due to the radial mounting by the holding ribs 27, 28. The cylindrical sleeve 29 also has a portion 31 for axial mounting of the shaft 15, which portion surrounds an axial end of the shaft 15.

In some embodiments, the holding ribs 27 and further holding ribs 28 may have stator laminations which form parts of the stator laminations of the associated stator and extend these into the associated flow space 11, 12, so that the magnetic field generated by the associated stator windings 23, 25 for driving the shaft 15 is brought closer to the associated rotor magnet 22, 24.

FIG. 3 shows a schematic view of a media gap motor 10 according to a further embodiment, which may be the further media gap motor 10′ shown in FIG. 1. The media gap motor 10 substantially corresponds to the media gap motor 10 described above, but has a droplet separator 32, which may also be provided accordingly in the media gap motor 10 described above with reference to FIG. 2, in particular in the flow space 11 and/or in the further flow space 12, but is preferably used in conjunction with the further media gap motor 10′ disposed in the anode circuit as shown in FIG. 1 and its flow space 11. The droplet separator 32 comprises a circumferential channel which is formed on the inner wall of the housing 26 in a region located in the axial direction between the stator windings 23 and the impeller 13 and in which any droplets, in particular water droplets, present in the media flow are separated. The droplet separator 32 is thus disposed at a transition to a portion 34 of the flow space 11 that accommodates the impeller 13 and is wider than a narrower portion 33 of the flow space 11 that accommodates the holding ribs 27. The droplets may flow along the path illustrated by the arrows, one of which is marked with the reference sign 35, from the media flow to the inner wall of the housing 26. The droplet separator 32 is connected to the drain line 16 so that the droplets may then be drained from the flow space 11. In some embodiments, the holding ribs 27 are angled (which is not shown in the schematic view shown) so that the holding ribs 27 are curved in the direction of flow. In this way, a swirl may be generated in the media flow, which optimizes the angle of impact on the impeller 13 and the path of the droplets to the droplet separator 32.

In the exemplary embodiment shown in FIG. 3, the cylindrical sleeve 29 at the radially inner end of the holding ribs 27 also serves to axially support the shaft 15 by acting on a step 36 of the shaft 15. In addition, a part of the housing 26 may form a further radial bearing 37 of the shaft 15.

A further schematic view of the media gap motor 10 is shown in FIG. 4, which illustrates the media gap motors 10, 10′ described with reference to each of the figures described above, when viewed in an axial direction. Blades of the downstream impeller 13 are shown schematically. The holding ribs 27 are disposed upstream of the impeller 13 and support the shaft 15 radially in conjunction with the cylindrical sleeve 29. In the example shown, the holding ribs 27 are formed by three individual ribs 27′, 27″, 27′″, which are disposed equidistantly to one another in the circumferential direction and which extend between the housing 26 and the sleeve 29. Spaces 38, 38′, 38″ are formed between the adjacent ribs, through which the entire conveyed medium flows in the example shown.

FIG. 5 shows a schematic view of the media gap motor 10 according to a further embodiment. In this exemplary embodiment, the impeller 13 is disposed at an upstream end of the shaft 15. In a portion adjoining this downstream there are disposed the holding ribs 27 with the cylindrical sleeve 29 for radial support of the shaft 15. Downstream of this there is disposed the rotor magnet 22, via which the shaft 15 is driveable in cooperation with the stator windings 23. This is adjoined at a downstream end by the further holding ribs 28 with the further cylindrical sleeve 30, which likewise radially support the shaft 15. The sleeves 29, 30 also form an axial bearing of the shaft 15 in that the sleeves 29, 30 engage with portions, one of which is identified by the reference sign 31, on associated steps 36, 36′ of the shaft 15.

FIG. 6 shows a media gap motor according to a further embodiment. In this embodiment, several impellers 13, 13′, 13″, 13′″ are provided, which are disposed in the flow space 11 and fixed non-rotatably to the shaft 15. In addition to the holding ribs 27 and further holding ribs 28 with associated sleeves 29, 30, further holding ribs 28′, 28″ with associated sleeves 30′, 30″ are provided at different axial points for radial support of the shaft 15. The holding ribs 27, 28, 28′, 28″ are all disposed in the flow space 11. The shaft 15 may be driven via the rotor magnet 22 and the other rotor magnet 24 as well as the associated stator windings 23, 25.

FIG. 7 shows a sectional view showing the shaft 15 described above in greater detail. The shaft 15 comprises a one-piece reinforcement 39 that extends to an axial end 40 of the shaft. The reinforcement 39 is made of chrome steel, for example, and has a first portion 41 and a second portion 42. The second portion 42 has a smaller outer diameter than the first portion 41 and the first portion 41 ends with a step 43 running around the shaft 15 in the circumferential direction, which represents an upward step when viewed from the second portion 42 to the first portion 41. In typical embodiments, the second portion 42 is located downstream of the first portion 41. Between the first portion 41 and the second portion as well as between the first portion 41 and the step 43, the outer diameter of the shaft 15 decreases in the direction of the second portion 42.

The reinforcement 39 has a continuous cavity 44, which has a first region 45 and a second region 46. In some embodiments, the cavity 44 extends through the entire shaft 15 and/or into the region of the turbine wheel 14, if provided and described above, and/or the further rotor magnet 24. The first region 45 of the cavity 44 is formed in the first portion 41 of the reinforcement 39, while the second region 46 of the cavity 44 is formed in the second portion 42 of the reinforcement 39. The rotor magnet 22 is accommodated in the first region 45 of the cavity 44. A shaft rod is accommodated in the second region 46 and may be connected to the rotor magnet 22.

The impeller 13, which may be made of aluminum, for example, is disposed in the second portion 42 of the reinforcement 39, for example pressed onto the reinforcement 39, in such a way that the impeller 13 bears, in particular flat, against the step 43 of the reinforcement 39, in the example shown against a surface of the step that extends transversely to the axial direction, and is supported against the step 43. An inner diameter of the reinforcement 39 in the first portion 41, which accommodates the rotor magnet 22, is larger than the outer diameter of the reinforcement 39 in the second portion 42, on which the impeller 13 is disposed. In this way, the rotor magnet 22 may have an outer diameter that is larger than an inner diameter of the impeller 13, whereby a greater efficiency of the media gap motor may be achieved through advantageous magnetic properties and flow properties.

Only features of the various embodiments disclosed in the exemplary embodiments may be combined with each other and claimed individually.

1. A media gap motor (10) comprising
a shaft (15), in which there is accommodated a rotor magnet (22),
a stator with stator windings (23) for electrically driving a rotation of the shaft (15),
a housing (26), which delimits a flow space (11) formed between the shaft (15) and the stator, and
an impeller (13) disposed in the flow space (11) and on the shaft (15),
characterized by
holding ribs (27), which extend in the flow space (11) between the housing (26) and the shaft (15) to radially support the shaft (15).

2. The media gap motor (10) according to claim 1, characterized by a turbine wheel (14) that is disposed on the shaft (15), wherein the housing (26) delimits a further flow space (11) and the turbine wheel (14) is disposed in the further flow space (11), and characterized by further holding ribs (28) that extend in the further flow space (11) between the housing (26) and the shaft (15) to radially support the shaft (15).

3. The media gap motor (10) according to claim 2, characterized in that the turbine wheel (14) is disposed between the further holding ribs (28) and the impeller (13).

4. The media gap motor (10) according to either one of claims 2 or 3, characterized in that the impeller (13) and the turbine wheel (14) are disposed between the holding ribs (27) and the further holding ribs (28).

5. The media gap motor (10) according to any one of claims 2 to 4, characterized in that a further rotor magnet is provided, which is accommodated in a portion of the shaft that is disposed in the further flow space (11), wherein further stator windings (25) are provided, which are configured to cooperate with the further rotor magnet (24) to electrically drive a rotation of the shaft (15).

6. The media gap motor (10) according to claim 5, characterized in that the further holding ribs (28) are disposed in the further flow space (11) so that the further holding ribs (28) have an axial overlap with the further rotor magnet (24) and/or with the further stator windings (25).

7. The media gap motor (10) according to any one of claims 2 to 6, characterized by a portion (31) for axially supporting the shaft (15), wherein the portion (31) is embodied as part of the holding ribs (27) or is connected to the holding ribs (27), wherein the portion (31) acts on a surface of the shaft (15) to axially support the shaft (15).

8. The media gap motor (10) according to any one of claims 1 to 7, characterized by a second radial bearing for the shaft (15), wherein the second radial bearing is disposed in the housing (26) of the media gap motor.

9. The media gap motor (10) according to any one of claims 1 to 8, characterized in that the shaft (15) has a one-piece reinforcement (39) with a first portion (41) and a second portion (42), wherein the rotor magnet (22) is accommodated inside the first portion (41) of the reinforcement (39) and the impeller (13) is disposed on the second portion (42) of the reinforcement (39).

10. The media gap motor (10) according to claim 9, characterized in that the reinforcement (39) is embodied as a component made from a continuous piece with constant material properties and as a non-joined component, wherein the reinforcement (39) is made of steel.

11. The media gap motor (10) according to either one of claims 9 or 10, characterized in that the reinforcement (39) runs through the impeller (13) with its second portion (42) over at least two thirds of the axial length of the impeller (13).

12. The media gap motor (10) according to any one of claims 9 to 11, characterized in that the first portion (41) of the reinforcement (39) has a greater outer diameter than the second portion (42) of the reinforcement (39).

13. The media gap motor (10) according to claim 12, characterized in that, between the first portion (41) and the second portion (42) of the reinforcement (39) there is formed a region in which the outer diameter of the reinforcement (39) reduces continuously.

14. The media gap motor (10) according to any one of claims 9 to 13, characterized in that the second portion (42) of the reinforcement (39) finishes with a step (43) against which the impeller (13) bears.

15. The media gap motor (10) according to claim 14, characterized in that the reinforcement (39) is embodied such that a substantially flush transition between the reinforcement (39) and the impeller (13) is provided in the region of the step (43) of the reinforcement (39).

16. The media gap motor (10) according to any one of claims 1 to 15, characterized by a droplet separator (32) that is disposed in the flow space (11) at the housing (26).

17. The media gap motor (10) according to claim 16, characterized in that the droplet separator (32) is disposed at a transition to a portion of the flow space (11) that accommodates the impeller (13).

18. The media gap motor (10) according to either one of claims 16 or 17, characterized in that the droplet separator (32) is disposed downstream of the holding ribs (28).

19. The media gap motor (10) according to any one of claims 1 to 18, characterized in that the holding ribs (27) are configured to generate a swirl in a medium conveyed in the flow space (11).

20. The media gap motor (10) according to claim 19, characterized in that the holding ribs (27) run at an angle to the axial direction such that a swirl is generated in the conveyed medium as a result of said medium flowing against the holding ribs (27).

21. The media gap motor (10) according to either one of claims 19 or 20, characterized in that the holding ribs (27) are disposed upstream of the impeller (13).

22. The media gap motor (10) according to any one of claims 1 to 21, characterized by a portion (31) for axially supporting the shaft (15), wherein the portion (31) is embodied as part of the holding ribs (27) or is connected to the holding ribs (27).

23. The media gap motor (10) according to claim 22, characterized in that the portion (31), to axially support the shaft (15), acts on a surface of the shaft (15) that for example has a surface normal in the axial direction.

24. The media gap motor (10) according to any one of claims 1 to 24, characterized in that the holding ribs (27) are disposed such that the holding ribs (27) have an axial overlap with the rotor magnet (22) and/or with the stator windings (23).

25. The media gap motor (10) according to claim 24, characterized in that the holding ribs (27), to optimize a magnetic flux, form an active part of a magnetic circuit formed by the rotor magnet (22) and stator windings (23).

26. The media gap motor (10) according to claim 25, characterized in that the holding ribs (27) have magnetically conductive properties.

27. A fuel cell system (1) comprising a media gap motor (10) according to any one of claims 1 to 26.

28. The fuel cell system according to claim 27, characterized in that the impeller (13) is disposed in a channel for guiding a fuel or in a channel for guiding an oxidizing agent.

29. The fuel cell system according to claim 28, wherein this is referred back to the media gap motor (10) of claim 2, characterized by an oxidizing agent feed line (5) for feeding oxidizing agent to a fuel cell (2) and a discharge line (6) for discharging oxidizing agent and/or a reaction product from the fuel cell (2), wherein the flow space (11) in which the impeller (13) is disposed forms part of the oxidizing agent feed line (5), and wherein the further flow space (11) in which the turbine wheel (14) is disposed forms part of the discharge line (6).

30. Use of a media gap motor (10) according to any one of claims 1 to 26 or of a fuel cell system according to any one of claims 27 to 29 for providing electrical drive power in a vehicle.
